(19) United States
(12) Patent Application Publication
(10) Pub. No.: US 2005/0135307 A1
(43) Pub. Date: Jun. 23, 2005

(54) Data transmitting method for wireless network using access point

(75) Inventors: Chil-youl Yang, Yongin-si (KR); Chang-yeul Kwon, Seongnam-si (KR); Tae-kon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/012,160

(22) Filed: Dec. 16, 2004

(30) Foreign Application Priority Data
Dec. 23, 2003 (KR) 10-2003-0095623

(51) Int. Cl. H04B 7/216; H04Q 7/00

(52) U.S. Cl. 370/329

(57) ABSTRACT

Disclosed is a method for transmitting data in a wireless network employing an access point. Each transmission opportunity for transmitting data between the access point and each station is set by using channel state information and traffic state information in relation to stations existing in the same communication area with the access point in a wireless network employing the access point, so that overheads can be reduced and a data processing amount can be improved.

### CROSS-REFERENCE TO RELATED APPLICATION

This application claims priority from Korean Patent Application No. 10-2003-0095623 filed on Dec. 23, 2003, in the Korean Intellectual Property Office, the disclosure of which is incorporated herein by reference in its entirety.

### BACKGROUND OF THE INVENTION

1. Field of the Invention

Methods consistent with the present invention relate to transmitting data in a wireless network, and more particularly, to transmitting data in a wireless network employing an access point, in which the access point detects channel state information and traffic state information in relation to each station, thereby determining whether or not data are transmitted, detecting frequency of a data transmission opportunity and rearranging data transmission order in a point coordination function (PCF) mode of the wireless network.

2. Description of the Prior Art

Recently, as the implementation of wireless local area networks (hereinafter, simply referred to as “WLAN”) have become essential in digital consumer electronics and mobile communication, implementation standards of consumer electronics wirelessly connected to computers, so that a new network is constructed, and the new network connected to various wireless networks, have been suggested.

Among other things, IEEE 802.11 is one of the IEEE 802 series, and the IEEE 802 series are specifications about local area network (LAN) implementation. All IEEE 802 networks have been standardized in the form of a media access control (MAC) and a physical layer.

Herein, the MAC refers to an assembly of rules determining methods for accessing to wireless media and transmitting data, and detailed methods for transmitting and receiving data belong to the physical layer.

The MAC of the IEEE 802.11 may selectively use a point coordination function (hereinafter, simply referred to as “PCF”) mode, in which an access point allows each station to transmit data through a polling method, a distributed coordination function (hereinafter, simply referred to as “DCF”) mode, which is a contention mode, or a mixed mode of the PCF mode and the DCF mode, depending on methods of sharing wireless media of the MAC.

Also, a contention-free mode is provided only in an infrastructure network employing an access point through all communication processes including a communication process between mobile stations in the same service area.

Generally, as shown in FIG. 1, the WLAN is divided into a contention-free interval and a contention interval with a period of a contention-free repetition interval. The PCF mode and the DCF mode are operated in the contention-free interval and the contention interval, respectively.

Herein, all data transmission is separated by a short inter-frame space (SIFS) during the contention-free interval, that is, during the PCF mode.

Meanwhile, if the contention-free interval starts, the access point transfers a “beacon” including a maximum contention free interval maintaining time to each station, and each station sets a network allocation vector (NAV) as the maximum contention free interval maintaining time in order to prevent other stations from accessing to the station during the maximum contention free interval maintaining time.

After transferring the beacon to each station, the access point transfers “CF-Poll” for endowing a first station with an authority for transferring frames to the access point. If the access point has a frame to be transferred to the first station, the access point uses “data (D1)+CF-Poll” frame.

Then, if the first station has a frame to be transferred, the first station transfers data (U1) as a response to the CF-POLL. Otherwise, the first station transfers a null frame.

Also, if the first station has received data (D1) from the access point, the first station transfers CF-Ack frame piggyback data, that is, “data (U1)+CF-Ack” or “CF-Ack” frame including the null frame.

The access point, which has received the data (U1)+CF-Ack frame from the first station, transfers “CF-Ack”, which is an acknowledgment for data transferred from the first station, to the first station. At the same time, the access point uses “data (D2)+CF-Poll” frame if the access point has a frame to be transferred and an authority for transferring a frame to a next station.

Accordingly, the access pointer uses “data (D2)+CF-Ack+CF-Poll” frame.

Hereinafter, the access point performs polling for each station and transfers an acknowledgement and data through the above described method.

Meanwhile, if the access point does not receive a response to a CF-Poll frame thereof from a predetermined station, the access point performs polling for a next station after PIFS (PCF inter-frame space).

Also, order and frequency for performing polling for each station by the access point are not defined in an IEEE 802.11 specification, but can be arbitrarily determined.

Through the above-mentioned data transmission method in a wireless network, the access point assigns an authority for transmitting data to each station according to a predetermined order, or gives priority for transmitting data according to each station and types of transmitted data.

However, the access point cannot effectively perform polling for each station because traffic information and channel information between the access point and each station is not utilized through the data transmission method.

In other words, if traffic information is not utilized, overheads occur due to unnecessary polling for a station handling less traffic, so that an overall data processing amount is reduced.

Also, if the channel information is not utilized, overheads may occur due to failure of data transmission for a station having an inferior channel state and re-transmission of the data, so that an overall data processing amount is reduced.

### SUMMARY OF THE INVENTION

Accordingly, the present invention has been made to solve the above-mentioned problems occurring in the prior art, and an aspect of the present invention is to provide a method for transmitting data in a wireless network employing an access point, which can improve a data processing amount during a contention free interval in the wireless network.

In order to accomplish this aspect, there is provided a method for transmitting data in a wireless network using an access point, the method comprising the steps of: 1) detecting channel state information and traffic state information of each station; and 2) setting mutually different transmission opportunities for transmitting data to each station through the channel state information and the traffic state information.

In order to accomplish this aspect, there is provided a method for transmitting data in a wireless network using an access point, the method comprising the steps of: 1) allowing each station to transfer channel state information and traffic state information of each station to the access point; and 2) receiving mutually-different transmission opportunities for transferring data to the access point according to a channel state and a traffic state.

Preferably, but not necessarily, the transmission opportunity is varied depending on weight determined through the channel state information and the traffic state information.

Preferably, but not necessarily, the channel state information includes at least one of a state of a response of each station, a possibility of successfully transmitting data, a data loss rate, a number of data re-transmission, a number of polling failure, a figure of received signal intensity, signal to noise, and a coding error rate.

Preferably, but not necessarily, the traffic state information includes the number of frames to be transferred to each station from among frames stored in a buffer of the access point, existence state (“more data” flag) information of data frames and existence state (“more frag” flag) information of fragmented frames added to a frame received from each station, a type of data to be transferred.

Preferably, but not necessarily, the transmission opportunity is obtained by changing a previous transmission opportunity according to the weight.

Preferably, but not necessarily, the method further comprises the steps of: 3) transferring data according to a changed transmission opportunity; and 4) determining whether or not the changed transmission opportunity is suitable while transferring the data.

Preferably, but not necessarily, in step 4), the transmission opportunity, which is set before transferring the data, is changed through the traffic state information and the channel state information while transferring the data.

### BRIEF DESCRIPTION OF THE DRAWINGS

The above and other aspects, features and advantages of the present invention will be more apparent from the following detailed description taken in, conjunction with the accompanying drawings, in which:

FIG. 1 is a view showing a method for transmitting data in a conventional wireless network;

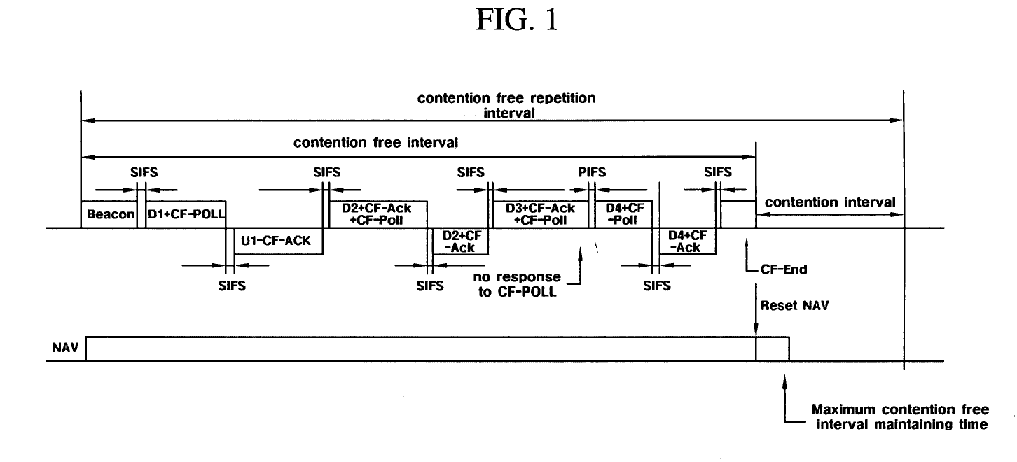

FIG. 2 is a view showing a wireless network using an access point according to the present invention;

FIG. 3 is a view showing a method for transmitting data in a wireless network using an access point according to the present invention;

FIG. 4 is a view showing a list of items included in channel state information and traffic state information and a method for determining weight for each item according to the present invention;

FIG. 5 is a view showing a data processing amount in a case of uniform traffic states and different channel states in a wireless network using an access point according to the present invention;

FIG. 6 is a view showing a data processing amount in a case of different traffic states and uniform channel states in a wireless network using an access point according to the present invention;

FIG. 7 is a view showing a data processing amount in a case of different traffic states and different channel states in a wireless network using an access point according to the present invention;

FIG. 8 is a view showing a data processing amount in a case in which plural stations having superior channel states co-exist in the same communication area in a wireless network using an access point according to the present invention;

FIG. 9 is a view showing a data processing amount in a case in which plural stations with superior channel states and plural stations with inferior channel states co-exist in the same communication area in a wireless network using an access point according to the present invention; and

FIG. 10 is a view showing a data processing amount in a case of setting a new transmission opportunity through channel state information when plural stations with superior channel states and plural stations with inferior channel states co-exist in the same communication area in a wireless network using an access point according to the present invention.

### DETAILED DESCRIPTION OF THE EXEMPLARY EMBODIMENTS

Hereinafter, embodiments of the present invention will be described in detail with reference to the accompanying drawings.

Advantages and features of the present invention, and methods for achieving them will be apparent to those skilled in the art from the detailed description of the embodiments together with the accompanying drawings. However, the scope of the present invention is not limited to the embodiments disclosed in the specification, and the present invention can be realized in various types. The described present embodiments are presented only for completely disclosing the present invention and helping those skilled in the art to completely understand the scope of the present invention, and the present invention is defined only by the scope of the claims. Additionally, the same reference numerals are used to designate the same elements throughout the specification and drawings.

Generally, a wireless network is mainly classified into an independent network and an infrastructure network, and basic elements included in the wireless network are stations making communication with each other within the same communication area.

Herein, in the independent network, a predetermined station directly makes communication with another station in the same communication area. In contrast, in the infrastructure network, an access point is used through all communication processes including a communication process between stations in a communication area.

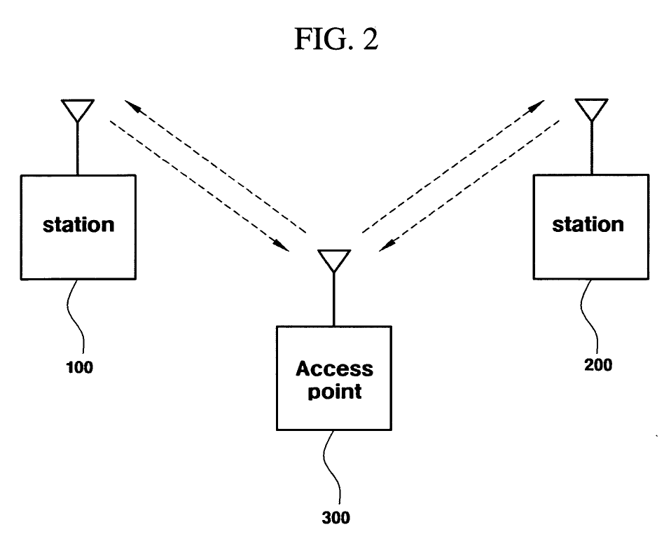

As shown in FIG. 2 of an infrastructure network, when a predetermined station 100 in an infrastructure network makes communication with another station 200, a station at a data transmission side transfers a frame to an access point 300, and the access point 300 transfers the frame to a station at a data reception side.

Herein, a wireless network employing the access point is divided into a contention-free interval and a contention interval with a period of a contention-free repetition interval, in which each interval is operated with the PCF mode and the DCF mode.

Also, in a case of the PCF mode, the access point transfers a “beacon” including a maximum contention free interval maintaining time to each station, and then, the access point transfers a polling frame for giving an authority for transferring data to each station in a predetermined order.

At this time, each station, which has received the beacon, sets a network allocation vector (NAV) by using the maximum contention free interval maintaining time in order to prevent accesses of other stations employing the DCF mode.

Hereinafter, a certain station, which has received the polling frame, transfers data or data and an acknowledgement as a response to the polling frame to the access point.

Herein, the access point arbitrarily determines the order and the frequency of polling frame transmission for all stations.

Herein, if the access point does not make an allowance for a traffic state between the access point and each station, overheads occur because an unnecessary polling frame is transmitted to a station handling less traffic. Therefore, an overall data processing rate can be lowered.

Also, if the access point does not consider a channel state between the access point and each station, overheads occur because the access point fails to transmit data or frequently retries to transmit the data to a station having an inferior channel state. Therefore, an overall data processing rate can be lowered.

According to the present invention, a data transmission opportunity for transmitting data between the access point and each station is suitably set through channel state information and traffic state information in a wireless network using an access point, so that overheads are reduced and an overall data processing rate is improved.

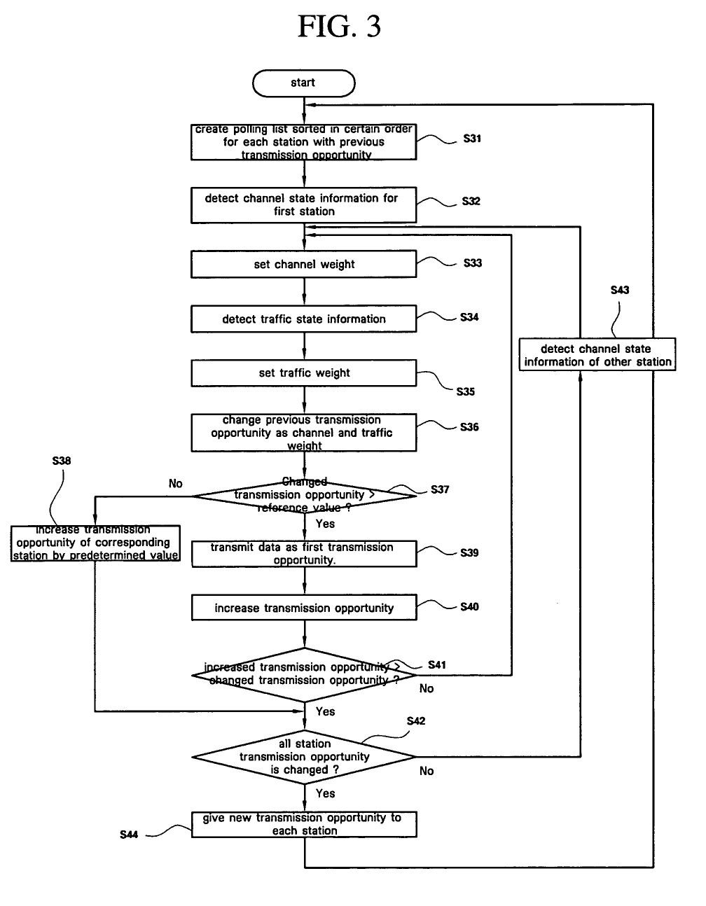

As shown in FIG. 3, through a method for transmitting data in a wireless network according to one embodiment of the present invention, the access point transfers a “beacon” for informing a contention free interval to each station, and then, each station sets NAV depending on a maximum contention free interval maintaining time included in the beacon.

Hereinafter, the access point creates a polling list, in which each station is sorted in a predetermined order, in order to transmit a polling frame for giving an authority for transferring data in a predetermined order to each station in the same communication area (step 31).

Herein, the polling list may have a previous transmission opportunity and the channel and traffic state information for each station.

Herein, it can be understood that a transmission opportunity is a value proportional to a data amount which can be transferred between the access point and each station.

Accordingly, the transmission opportunity is proportional to an interval (time) in which each station can transmit data to the access point.

In the meantime, although a maximum contention free interval maintaining time is generally determined by using a beacon frame transferred to each station from the access point, according to one embodiment of the present invention, the maximum contention free interval maintaining time can be set in consideration of each transmission opportunity given to each station such that each station can transmit data during each transmission opportunity assigned thereto.

Subsequently, channel state information about a first station from among stations included in the polling list is detected (step 32).

The channel state information can be detected by using a response to each polling frame transferred to each station from the access point.

The channel state information includes at least one of a response state to each polling frame, a possibility of successfully transmitting a frame to a station corresponding to a polling frame, a number of transmission failure for a frame to a station corresponding to a polling frame, a number of re-transmission for a frame due to a transmission failure for the frame, a frame loss rate, a received signal strength indication (RSSI), a signal-to-noise ratio (SNR), a bit error rate (BER), and other channel state information.

The access point sets a channel weight, which is a variable for changing a transmission opportunity for transmitting/receiving data to/from the station, according to the channel state information (step 33).

Herein, the channel weight can be set as positive or as negative. As the weight for a corresponding station increases, a positive weight allows a transmission opportunity to increase.

Also, as the weight for a corresponding station decreases, a negative weight allows a transmission opportunity to decrease.

After setting the channel weight, traffic state information, which is another variable for changing a transmission opportunity, is detected (step 34).

Herein, the traffic state information includes at least one of the number of frames to be transferred to each station from among frames stored in a buffer of the access point, existence state (“more data” flag) information of data frames and existence state (“more frag” flag) information of fragmented frames added to a frame received from each station, a type of data to be transferred, etc.

The access point sets a traffic weight according to the traffic state information and the channel weight (step 35).

Herein, the traffic weight can be set as positive or as negative, similar to the channel weight.

According to one embodiment of the present invention, an example in which the channel weight and the traffic weight are set as negative will be described below.

Also, the channel weight and the traffic weight are set in consideration of the collected information and the traffic state information. At this time, the channel weight and the traffic weight can be set by considering all information, or can be set according to the importance of each information, selectively.

For example, when setting the channel weight, the number of re-transmission for a frame caused by transmission failure and a frame loss rate can be set as high weight.

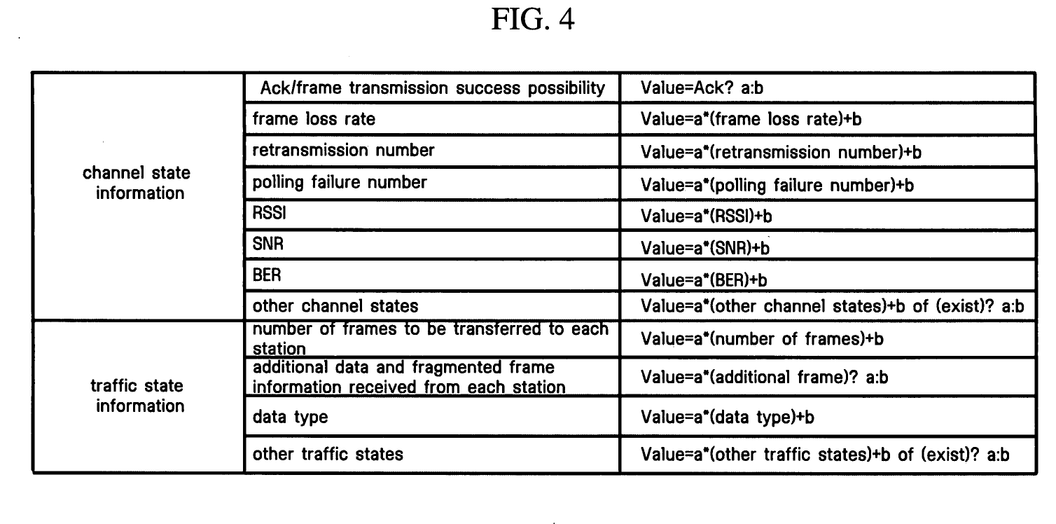

That is, as shown in FIG. 4, the importance of information included in the channel state information and the traffic state information can be adjusted higher than the importance of other information by using “a” and “b”, which are constants or formulas defined by users.

For instance, when a user raises the importance of the number of re-retransmissions for a frame from among the channel state information and importance of a data type from among the traffic state information, the user sets constants assigned to the number of re-transmissions for a frame and the data type higher than other constants assigned to other channel state information and traffic state information. Therefore, the relative importance of the number of re-transmissions for a frame and the data type can be raised above other channel state information and traffic state information.

The access point sets a new transmission opportunity for transmitting/receiving data to/from the station by changing a previous transmission opportunity according to the channel weight and the traffic weight (step 36).

Herein, the previous transmission opportunity included in the polling list is changed into a new transmission opportunity according to the channel weight and the traffic weight, and a currently changed transmission opportunity is employed when the access point transmits a polling frame to a corresponding station in the future.

Hereinafter, after comparing a transmission opportunity of a corresponding station with a predetermined reference value, if the transmission opportunity is smaller than the reference value (step 37), the transmission opportunity of the corresponding station can be increased by a predetermined value (step 38) in order to prevent transmission failure caused by a smaller number of transmission opportunity of the corresponding station.

At this time, when a transmission opportunity is set in consideration of the weight, a station with a transmission opportunity smaller than the reference value may have a minimum transmission opportunity.

That is, a station having a smaller transmission opportunity may have a reinforced authority for transmitting data by compensating for the transmission opportunity of the station.

Then, the access point and each station start to transmit a predetermined data depending on the changed transmission opportunity. At this time, in order to determine whether or not a transmission opportunity for the data to be transferred from the access point or each station is suitable for the changed transmission opportunity, the transmission opportunity for the data is gradually increased up to a total transmission opportunity based on the changed transmission opportunity, thereby determining the suitability for the changed transmission opportunity.

In other words, the access point or each station transmits data according to a first transmission opportunity (step 39). After transmitting the data, the first transmission opportunity is increased (step 40).

If the increased transmission opportunity is smaller than the total transmission opportunity based on the changed transmission opportunity, steps 33 to 37 of changing a transmission opportunity for the access point or each station through channel state information or traffic state information are performed (step 41).

Herein, when a transmission opportunity is changed through channel state information and traffic state information while increasing the transmission opportunity, an amount of data to be transferred is reduced. As an amount of data to be transferred is reduced, the changed transmission opportunity is decreased, so that the changed transmission opportunity is decreased below the reference value.

Also, the transmission opportunity is increased by a predetermined value (step 38) such that data can be transmitted in a next contention free interval when the changed transmission opportunity is decreased below the reference value.

Accordingly, a transmission opportunity changed through channel state information and traffic state information can be flexibly varied depending on data transferred from a current access point or each station before transmitting the data.

After that, if the number of stations having changed transmission opportunities does not exceed the number of all stations (step 42), channel state information for a next station is detected (step 43), and then, a series of steps 33 to 41 of changing the transmission opportunities are repeatedly performed until transmission opportunities for all stations are changed.

Then, if transmission opportunities for all stations are changed into new transmission opportunities through the channel state information and the traffic state information, each transmission opportunity is assigned to each station in a next contention free interval based on the changed transmission opportunities (step 44).

In the mean time, each transmission opportunity for each station can be provided as the ratio of each transmission opportunity for each station to transmission opportunities for all stations during the maximum contention free interval maintaining time.

This is because the maximum contention free interval maintaining time can be increased to a predetermined limit and cannot be limitlessly increased.

If a transmission opportunity is changed as described above, a station handling less traffic may have a small transmission opportunity and a station handling greater traffic may have a greater transmission opportunity.

Also, a station having a superior channel state may have a transmission opportunity greater than that of a station having an inferior channel state.

Hereinafter, when setting a transmission opportunity through channel state information and traffic state information in the method for transmitting data in a wireless network using an access point, a data processing amount will be described.

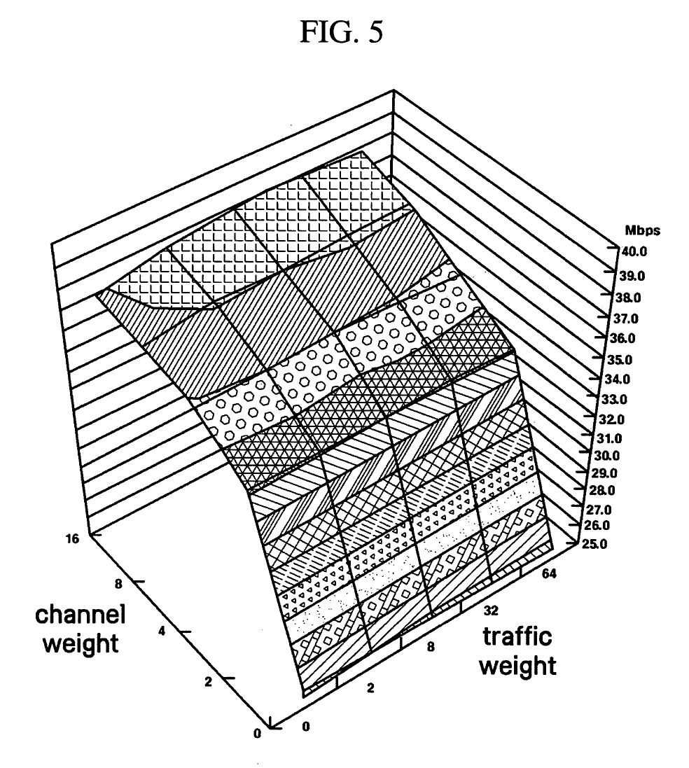

First, if traffic of all stations in the same communication area is uniform, as shown in FIG. 5, variation of a data processing amount rarely occurs when the traffic weight is changed. In contrast, the data processing amount is improved when the channel weight is changed.

In detail, on an assumption that the traffic weight is ‘0’, the data processing amount is improved from 25.745817 Mbps to 36.937728 Mbps if the channel weight increases from ‘0’ to ‘16’.

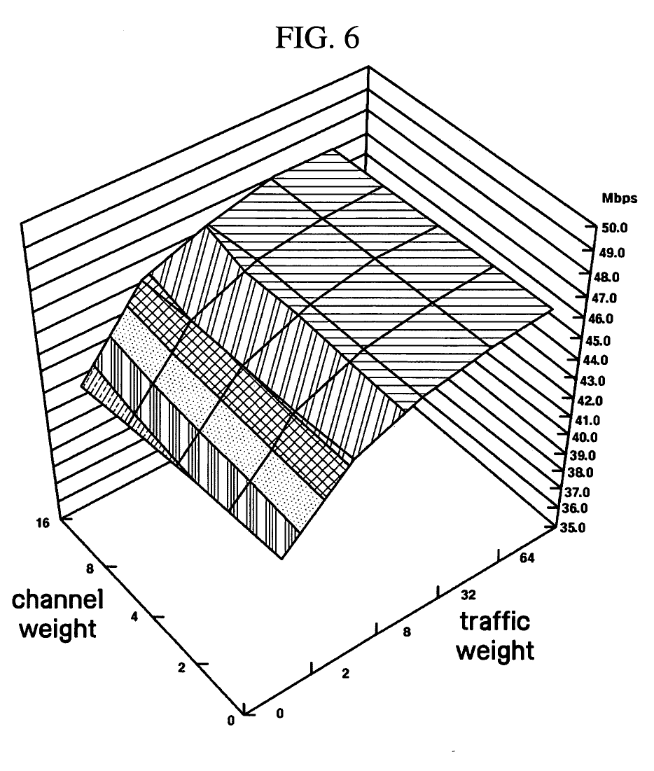

Secondly, if channels of all stations in the same communication area are superior, but traffic thereof is not uniform, variation of a data processing amount is little when the channel weight is changed. In contrast, the data processing amount is improved according to a change of the traffic weight as shown in FIG. 6.

In detail, on an assumption that the channel weight is ‘0’, the data processing amount is improved from 42.483475 Mbps to 42:6.756454 Mbps if the traffic weight increases from ‘0’ to ‘64’.

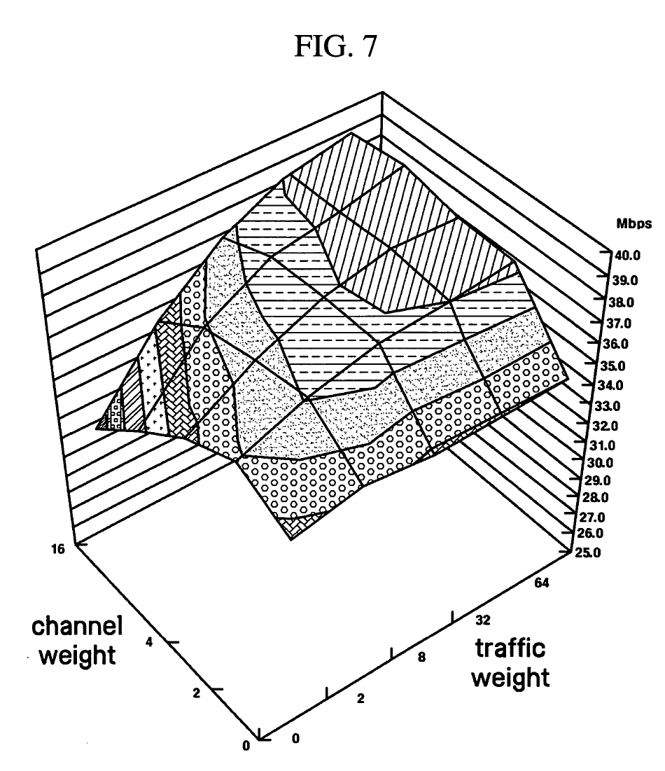

Therefore, when setting each transmission opportunity of each station through channel state information and traffic state information with respect to all stations in the same communication area with the access point, an overall data procession amount is improved according to changes of the channel weight and the traffic weight as shown in FIG. 7.

That is, if both channel weight and traffic weight are ‘0’, the data processing amount is about 34.655846 Mbps, however, if the channel weight and the traffic weight are ‘16’and ‘64’, respectively, the data processing amount is improved to 38.631628 Mbps.

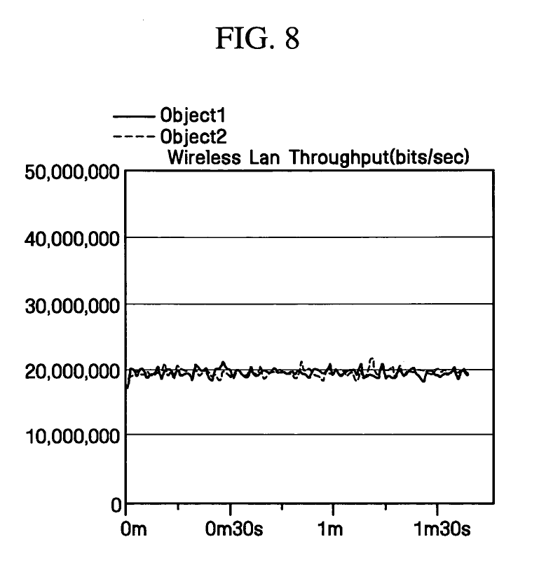

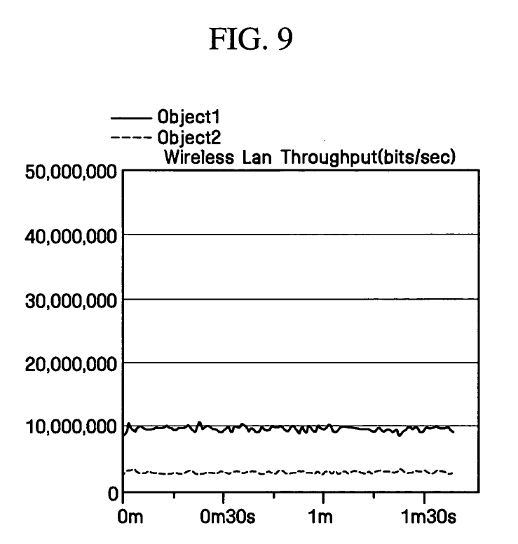

In addition, if a channel state and a traffic state are superior, a data procession amount of each station is uniform as shown in FIG. 8. In contrast, if a channel state and a traffic state for a predetermined station are inferior, a channel state and a traffic state for another station within the same communication area with the predetermined station are inferior as shown in FIG. 9.

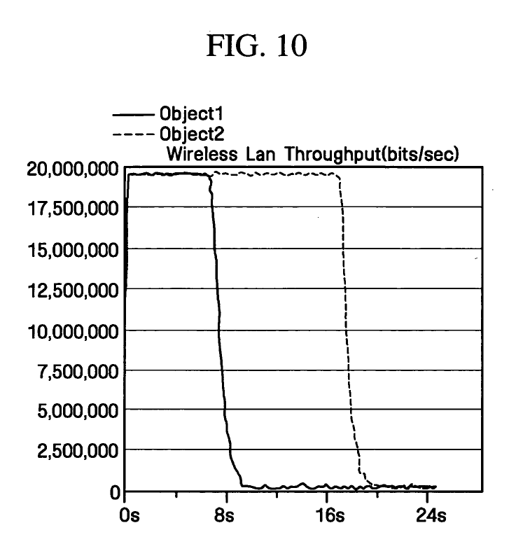

Accordingly, when setting each transmission opportunity of each station according to the channel state information and the traffic state information, even though a data processing amount of a predetermined station in the same communication area is lowered, it is possible to prevent data processing amounts of other stations from being lowered if the transmission opportunity is set according to the channel state information and the traffic state information as shown in FIG. 10.

As described above, according to the present invention, each transmission opportunity for transmitting data between an access point and each station is set by using channel state information and traffic state information in relation to stations existing in the same communication area with the access point in a wireless network using the access point, so that overheads can be reduced and a data processing amount can be improved.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A method for transmitting data in a wireless network using an access point, the method comprising the steps of:
1) detecting a first channel state information and a first traffic state information of a first station and detecting a second channel state information and a second traffic state information of a second station; and
2) setting a first transmission opportunity for transmitting first data to the first station according to the first channel state information and the first traffic state information and setting a second transmission opportunity for transmitting second data to the second station according to the second channel state information and the second traffic state information, wherein the first and the second transmission opportunities are mutually different.

2. The method as claimed in claim 1, wherein the first transmission opportunity is changed depending on a first weight determined through the first channel state information and the first traffic state information and the second transmission opportunity is changed depending on a second weight determined through the second channel state information and the second traffic state information.

3. The method as claimed in claim 2, wherein each of the first and the second channel state information includes at least one of a state of a response of each station, a possibility of successfully transmitting data, a data loss rate, a number of data re-transmission, a number of polling failures, a received signal strength indication (RSSI), a signal-to-noise ratio (SNR), a bit error rate (BER), and other channel state information.

4. The method as claimed in claim 2, wherein each of the first and the second traffic state information includes at least one of a number of frames to be transferred to each station from among a plurality of frames stored in a buffer of the access point, existence state information of data frames and existence state information of fragmented frames added to a frame received from each station, a type of data to be transferred, and other traffic state information.

5. The method as claimed in claim 4, wherein the first transmission opportunity is obtained by changing a previous first transmission opportunity according to the first weight.

6. The method as claimed in claim 5, further comprising the steps of:
3) transferring the first and the second data according to the first and the second transmission opportunities, respectively; and
4) determining whether or not the first and the second transmission opportunities are suitable while transferring the first and the second data, respectively.

7. The method as claimed in claim 6, wherein, in step 4), the first transmission opportunity, which is set before transferring the first data, is changed through the first traffic state information and the first channel state information while transferring the first data, and the second transmission opportunity, which is set before transferring the second data, is changed through the second traffic state information and the second channel state information while transferring the second data.

8. A method for transmitting data in a wireless network using an access point, the method comprising the steps of:
1) allowing a first station to transfer first channel state information and first traffic state information and allowing a second station to transfer second channel state information and second traffic state information to the access point; and
2) receiving a first transmission opportunity for transferring first data to the access point according to the first channel state information and the first traffic state information and receiving a second transmission opportunity for transferring second data to the access point according to a second channel state information and a second traffic state information, wherein the first and the second transmission opportunities are mutually different.

9. The method as claimed in claim 8, wherein the first transmission opportunity is changed depending on a first weight determined through the first channel state information and the first traffic state information and the second transmission opportunity is changed depending on a second weight determined through the second channel state information and the second traffic state information.

10. The method as claimed in claim 9, wherein each of the first and the second channel state information includes at least one of a state of a response of each station, a possibility of successfully transmitting data, a data loss rate, a number of data re-transmission, a number of polling failures, a received signal strength indication (RSSI), a signal-to-noise ratio (SNR), a bit error rate (BER), other channel state information.

11. The method as claimed in claim 9, wherein each of the first and the second traffic state information includes at least one of a number of frames to be transferred to each station from among a plurality of frames stored in a buffer of the access point, existence state information of data frames and existence state information of fragmented frames added to a frame received from each station, a type of data to be transferred, and other traffic state information.

12. The method as claimed in claim 9, wherein the first transmission opportunity is obtained by changing a previous first transmission opportunity, which was previously set, depending on the first weight.

13. The method as claimed in claim 12, further comprising the steps of:
3) transferring the first and the second data according to the first and the second transmission opportunities, respectively; and
4) determining whether or not the first and the second transmission opportunities are suitable while transferring the first and the second data, respectively.

14. The method as claimed in claim 13, wherein, in step 4), the first transmission opportunity set before transferring the first data is changed through the first traffic state information and the first channel state information while transferring the first data.
